(19) United States
(12) Patent Application Publication
(10) Pub. No.: US 2022/0160043 A1
(43) Pub. Date: May 26, 2022

(54) APPARATUS FOR HEATING AEROLSOLISABLE MATERIAL AND METHOD OF ARRANGING AN APPARATUS

(71) Applicant: Nicoventures Trading Limited, London (GB)

(72) Inventors: Zexin WU, Shenzhen, Guangdong (CN); Chi Wai FUNG, Shenzhen, Guangdong (CN); Guang Yan WEI, Shenzhen, Guangdong (CN); Conor John MCGRATH, London (GB); Jai-Ram TAANK, London (GB); Matthew TIDNAM, London (GB)

(21) Appl. No.: 17/600,592

(22) PCT Filed: Apr. 4, 2019
(86) PCT No.: PCT/CN2019/081581

§ 371 Date: Sep. 30, 2021

(51) Int. Cl. A24F 40/485; A24F 40/53; A24F 40/42; A24F 40/60

(52) U.S. Cl. CPC A24F 40/485; A24F 40/60; A24F 40/42; A24F 40/53

(57) ABSTRACT

An aerosol provision system comprises a reservoir for containing an aerosol precursor material; an inlet port and an outlet port both fluidly connected to the reservoir; and a control unit configured to supply a pressurized fluid to the reservoir via the inlet port to increase the pressure within the reservoir relative to the pressure external to the reservoir to force the aerosol precursor material to exit the reservoir via the outlet port.

### CROSS-REFERENCE TO RELATED APPLICATIONS

This application is a National Phase entry of PCT Application No. PCT/CN2019/081581, filed Apr. 4, 2019, the entire disclosure of which is incorporated herein by reference.

### TECHNICAL FIELD

The present disclosure relates to apparatus for heating-aerosolizable material to volatilise at least one component of the aerosolizable material, and methods of arranging an apparatus for heating aerosolizable material to volatilise at least one component of the aerosolizable material.

### BACKGROUND

Smoking articles, such as cigarettes, cigars and the like, burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

### SUMMARY

A first aspect of the present disclosure provides an apparatus for heating aerosolizable material to volatilise at least one component of the aerosolizable material to form an aerosol for inhalation by a user. The apparatus comprises: a heating arrangement comprising an elongate heating zone for receiving and heating aerosolizable material; a power zone for installing a power source for providing heating power to heat the heating zone; and control circuitry for controlling the heating power; wherein the power zone and the control circuitry are arranged in sequence in a direction substantially parallel with a longitudinal axis of the apparatus; and wherein the elongate heating zone is arranged adjacent to and substantially in parallel with the power zone and the control circuitry.

In an exemplary embodiment, the longitudinal axis of the apparatus is a major axis of the apparatus. In an exemplary embodiment, the longitudinal axis of the apparatus is parallel to a longitudinal axis of the elongate heating zone.

In an exemplary embodiment, the longitudinal axis of the elongate heating zone is arranged in parallel to a longitudinal axis of each of the power zone and the control circuitry.

In an exemplary embodiment, the elongate heating zone is arranged to a side of the power zone and a side of the control circuitry.

In an exemplary embodiment, the elongate heating zone is located within a combined span of the power zone and the control circuitry in the direction substantially parallel with a longitudinal axis of the elongate heating zone.

In an exemplary embodiment, an end of the power source is located closer to a proximal end of the apparatus than an end of the elongate heating zone is to the proximal end of the apparatus.

In an exemplary embodiment, an end of the control circuitry is located closer to a distal end of the apparatus than an end of the elongate heating zone is to the distal end of the apparatus.

In an exemplary embodiment, the apparatus comprises an opening for receiving aerosolizable material, wherein the power zone is arranged closer to the opening than the control circuitry is arranged to the opening.

In an exemplary embodiment, the control circuitry comprises a plurality of printed circuit boards (PCBs) that are arranged substantially in parallel in a direction substantially perpendicular to the longitudinal axis of the apparatus. In an exemplary embodiment, each PCB has a depth with a direction in parallel with a direction of a depth of the apparatus. In an exemplary embodiment, each one of the plurality of PCBs are electrically connected. In an exemplary embodiment, the plurality PCBs are provided as a split PCB. In an exemplary embodiment, one of the plurality of PCBs comprises an electrical connection port for electrical connection between the apparatus and an external electrical source. In an exemplary embodiment, the connection port is arranged at an end opposite an opening for receiving aerosolizable material and the electrical connection port faces outwardly in the direction substantially perpendicular to the longitudinal axis of the apparatus. In an exemplary embodiment, the direction substantially perpendicular to the longitudinal axis of the apparatus is a lateral direction.

In an exemplary embodiment, the power zone is arranged alongside the heating zone and only along a portion of the length of the heating zone.

In an exemplary embodiment, the control circuitry is arranged alongside the heating zone and only along a portion of the length of the heating zone.

In an exemplary embodiment, the power zone is arranged along a first portion of the length of the heating zone and the control circuitry is arranged along a second portion of the length of the heating zone, wherein a size of the first portion is greater than a size of the second portion.

In an exemplary embodiment, each PCB has substantially the same length.

In an exemplary embodiment, each PCB is substantially planar.

In an exemplary embodiment, each PCB has a length that is less than a length of the power zone. In an exemplary embodiment, the length of each PCB is greater than half the length of the power zone.

In an exemplary embodiment, each PCB has a length between 30 mm and 40 mm. In an exemplary embodiment, the length is between 35 mm and 38 mm. In an exemplary embodiment, the length is between 36 mm and 37 mm. In an exemplary embodiment, the length is around 36.6 mm.

In an exemplary embodiment, a depth of at least one of the PCBs is between 1 mm and 2 mm. In an exemplary embodiment, the depth is between 1 mm and 1.5 mm. In an exemplary embodiment, the depth is around 1.2 mm.

In an exemplary embodiment, the apparatus comprises a first chassis for independently supporting the power zone and a second chassis for independently supporting the heating arrangement and control circuitry.

In an exemplary embodiment, the power zone has a volume greater than a volume of the control circuitry and a volume of the elongate heating zone. In an exemplary embodiment, the volume of the elongate heating zone is greater than the volume of the control circuitry.

In an exemplary embodiment, a depth of the power zone is greater than a depth of the control circuitry and a depth of the elongate heating zone. In an exemplary embodiment, a width of the power zone is greater than a depth of the elongate heating zone.

In an exemplary embodiment, the aerosolizable material comprises tobacco is reconstituted, is in the form of a gel, comprises an amorphous solid, or combinations thereof.

A second aspect of the present disclosure provides a method of arranging an apparatus for heating aerosolizable material to volatilise at least one component of the aerosolizable material to form an aerosol for inhalation by a user. The method comprises the steps of: providing a heating arrangement comprising an elongate heating zone for receiving and heating aerosolizable material; and arranging in sequence a power zone and control circuitry in a direction substantially parallel with a longitudinal axis of the apparatus, wherein the power zone is for installing a power source for providing heating power to heat the heating zone; and wherein the elongate heating zone is arranged adjacent to and substantially in parallel with the power zone and the control circuitry.

In an exemplary embodiment, the arranging comprises arranging in sequence a power source of the power zone and the control circuitry in the direction substantially parallel with the longitudinal axis of the apparatus.

In an exemplary embodiment, the method comprises installing a power source in the power zone.

In an exemplary embodiment, the aerosolizable material comprises tobacco, is reconstituted, is in the form of a gel, comprises an amorphous solid, or combinations thereof.

Further features and advantages of the disclosure will become apparent from the following description of preferred embodiments of the disclosure, given by way of example only, which is made with reference to the accompanying drawings.

### BRIEF DESCRIPTION OF THE DRAWINGS

Embodiments of the disclosure will now be described, by way of example only, with reference to the accompanying drawings, in which:

FIG. 1 shows a schematic perspective view of an example of an apparatus for heating aerosolizable material to volatilise at least one component of the aerosolizable material, wherein the apparatus is shown with a consumable article comprising aerosolizable material inserted;

FIG. 2 shows a schematic front view of the example apparatus of FIG. 1 with the consumable article inserted;

FIG. 3 shows a schematic right-side view of the example apparatus of FIG. 1 with the consumable article inserted;

FIG. 4 shows a schematic left-side view of the example apparatus of FIG. 1 with the consumable article inserted;

FIG. 5 shows a schematic front cross-sectional view of the example apparatus of FIG. 1 with the consumable article inserted through line A-A shown in FIG. 4;

FIG. 6 shows a schematic front cross-sectional view of the example apparatus of FIG. 1 without a consumable article inserted; and

FIG. 7 shows a flow diagram showing an example of a method of arranging an apparatus for heating aerosolizable material to volatilise at least one component of the aerosolizable material.

### DETAILED DESCRIPTION

As used herein, the term “aerosolizable material” includes materials that provide volatilised components upon heating, typically in the form of vapor or an aerosol. “Aerosolizable material” may be a non-tobacco-containing material or a tobacco-containing material. “Aerosolizable material” may, for example, include one or more of tobacco per se, tobacco derivatives, expanded tobacco, reconstituted tobacco, tobacco extract, homogenised tobacco or tobacco substitutes. The aerosolizable material can be in the form of ground tobacco, cut rag tobacco, extruded tobacco, reconstituted tobacco, reconstituted aerosolizable material, liquid, gel, amorphous solid, gelled sheet, powder, or agglomerates, or the like. “aerosolizable material” also may include other, non-tobacco, products, which, depending on the product, may or may not contain nicotine. “Aerosolizable material” may comprise one or more humectants, such as glycerol or propylene glycol. The term “aerosol generating material” may also be used herein interchangeably with the term “aerosolizable material”.

As noted above, the aerosolizable material may comprise an “amorphous solid”, which may alternatively be referred to as a “monolithic solid” (i.e. non-fibrous), or as a “dried gel”. The amorphous solid is a solid material that may retain some fluid, such as liquid, within it. In some cases, the aerosolizable material comprises from about 50 wt %, 60 wt % or 70 wt % of amorphous solid, to about 90 wt %, 95 wt % or 100 wt % of amorphous solid. In some cases, the aerosolizable material consists of amorphous solid.

As used herein, the term “sheet” denotes an element having a width and length substantially greater than a thickness thereof. The sheet may be a strip, for example.

As used herein, the term “heating material” or “heater material”, in some examples, refers to material that is heatable by penetration with a varying magnetic field, for example when the aerosolizable material is heated by an inductive heating arrangement.

Other forms of heating a heating material include resistive heating which involves electrically resistive heating elements that heat up when an electric current is applied to the electrically resistive heating element, thus transferring heat by conduction to the heating material.

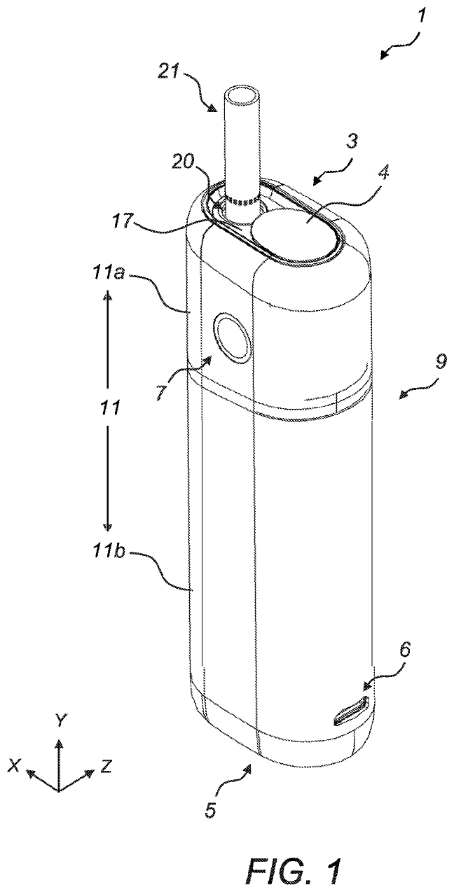

Referring to FIG. 1, there is shown a schematic perspective view of an apparatus 1 according to an embodiment of the disclosure. The apparatus 1 is for heating aerosolizable material to volatilise at least one component of the aerosolizable material to form an aerosol for inhalation by a user. In this embodiment, the aerosolizable material comprises tobacco, and the apparatus 1 is a tobacco heating product (also known in the art as a tobacco heating device or a heat-not-burn device). The apparatus 1 is a handheld device for inhalation of the aerosolizable material by the user of the handheld device.

The apparatus 1 comprises a first end 3 and a second end 5, opposite the first end 3. The first end 3 is sometimes referred to herein as the mouth end or proximal end of the apparatus 1. The second end 5 is sometimes referred to herein as the distal end of the apparatus 1. The apparatus 1 has an on/off button 7 to allow the apparatus 1, as a whole, to be switched on and off as desired by a user of the apparatus 1.

In broad outline, the apparatus 1 is configured to generate an aerosol to be inhaled by a user by heating an aerosol generating material. In use, a user inserts an article 21 into the apparatus 1 and activates the apparatus 1, e.g. using the button 7, to cause the apparatus 1 to begin heating the aerosol generating material. The user subsequently draws on a mouthpiece 21b of the article 21 near the first end 3 of the apparatus 1 to inhale an aerosol generated by the apparatus 1. As a user draws on the article 21, generated aerosol flows through the apparatus 1 along a flow path towards the proximal end 3 of the apparatus 1.

In examples a vapor is produced that then at least partly condenses to form an aerosol before exiting the apparatus 1 to be inhaled by the user.

In this respect, first it may be noted that, in general, a vapor is a substance in the gas phase at a temperature lower than its critical temperature, which means that for example the vapor can be condensed to a liquid by increasing its pressure without reducing the temperature. On the other hand, in general, an aerosol is a colloid of fine solid particles or liquid droplets, in air or another gas. A “colloid” is a substance in which microscopically dispersed insoluble particles are suspended throughout another substance.

For reasons of convenience, as used herein the term aerosol should be taken as meaning an aerosol, a vapor or a combination of an aerosol and vapor.

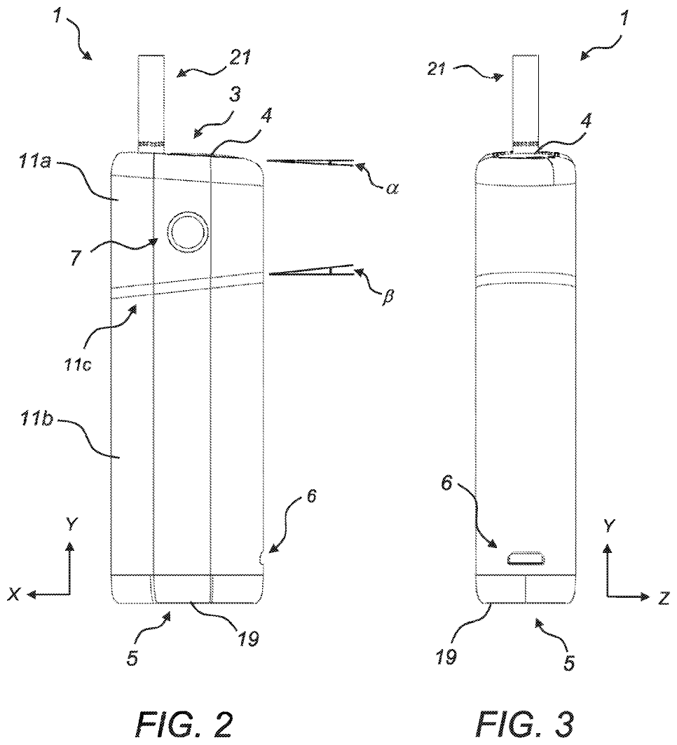

The apparatus 1 comprises a casing 9 for locating and protecting various internal components of the apparatus 1. The casing 9 is therefore an external housing for housing the internal components. In the embodiment shown, the casing 9 comprises a sleeve 11 that encompasses a perimeter of the apparatus 1, capped with a top panel 17, at the first end 3, which defines generally the ‘top’ of the apparatus 1 and a bottom panel 19, at the second end 5 (see FIGS. 2 to 5), which defines generally the ‘bottom’ of the apparatus 1.

The sleeve 11 comprises a first sleeve 11a and a second sleeve 11b. The first sleeve 11a is provided at a top portion of the apparatus 1, shown as an upper portion of the apparatus 1, and extends away from the first end 3. The second sleeve 11b is provided at a bottom portion of the apparatus 1, shown as a lower portion of the apparatus 1, and extends away from the second end 5. The first sleeve 11a and second sleeve 11b each encompass a perimeter of the apparatus 1. That is, the apparatus 1 comprises a longitudinal axis in a Y-axis direction, and the first sleeve 11a and the second sleeve 11b each surround the internal components in a direction radial to the longitudinal axis. The longitudinal axis is a major axis of the apparatus 1.

In this embodiment, the first sleeve 11a and a second sleeve 11b are removably engaged with each other. In this embodiment, the first sleeve 11a is engaged with the second sleeve 11b in a snap-fit arrangement comprising grooves and recesses.

In some embodiments, the top panel 17 or the bottom panel 19 may be removably fixed to the corresponding first and second sleeves 11a, 11b, respectively, to permit easy access to the interior of the apparatus 1. In some embodiments, the sleeve 11 may be “permanently” fixed to the top panel 17 or the bottom panel 19, for example to deter a user from accessing the interior of the apparatus 1. In one embodiment, the panels 17 and 19 are made of a plastics material, including for example glass-filled nylon formed by injection moulding, and the sleeve 11 is made of aluminium, though other materials and other manufacturing processes may be used.

The top panel 17 of the apparatus 1 has an opening 20 at the mouth end 3 of the apparatus 1 through which, in use, the consumable article 21 containing aerosolizable material is inserted into the apparatus 1 and removed from the apparatus 1 by a user. In this embodiment, the consumable article 21 acts as the mouthpiece for the user to place between lips of the user. In other embodiments, an external mouthpiece may be provided wherein at least one volatilised component of the-aerosolizable material is drawn through the mouthpiece. When an external mouthpiece is used, the aerosolizable material is not provided in the external mouthpiece.

The opening 20 in this embodiment is opened and closed by a door 4. In the embodiment shown, the door 4 is movable between a closed position and an open position to allow for insertion of the consumable article 21 into the apparatus 1 when in the open position. The door 4 is configured to move bi-directionally along an X-axis direction.

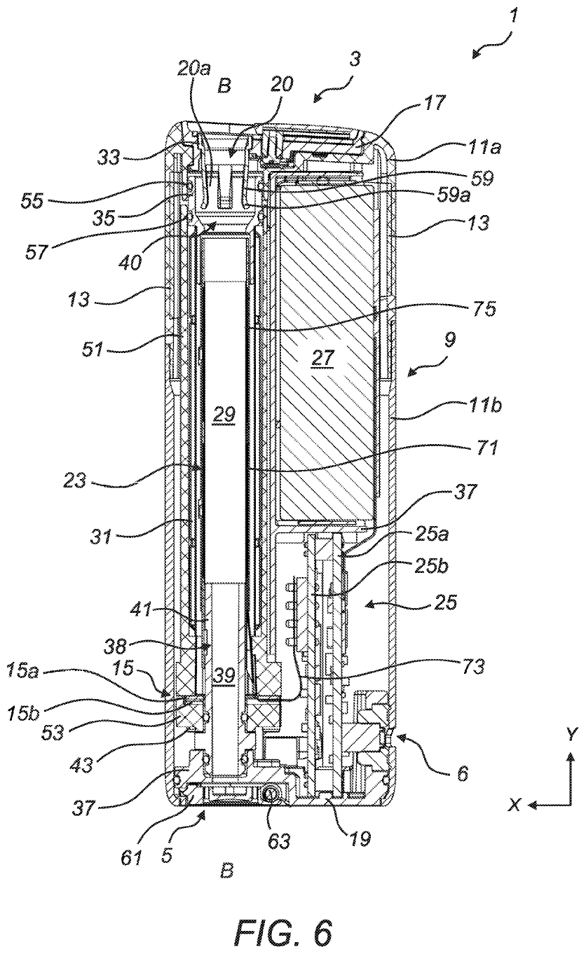

A connection port 6 is shown at the second end 5 of the apparatus 1. The connection port 6 is for connection to a cable and a power source 27 (shown in FIG. 6) for charging the power source 27 of the apparatus 1. The connection port 6 extends in a Z-axis direction from a front side of the apparatus 1 to a rear side of the apparatus 1. As shown in FIG. 3, the connection port 6 is accessible on a right-side of the apparatus 1 at the second end 5 of the apparatus 1. Advantageously, the apparatus 1 may stand on the second end 5 whilst charging or to provide a data connection through the connection port 6. In the embodiment shown, the connection port 6 is a universal serial bus (USB) socket.

Referring to FIG. 2, the first sleeve 11a comprises a surface at the first end 3 of the apparatus 1 that is tapered. The tapered surface comprises a first angle α with respect to a surface of the second sleeve 11b at the second end 5. In this embodiment, the surface of the second sleeve 11b at the second end 5 is substantially parallel to the X-axis direction. Therefore, as shown, the consumable article 21 is insertable through the opening 20 (shown in FIG. 1) at a proximal portion of the first end 3. Where the first sleeve 11a and second sleeve 11b meet at a join 11c, a second angle β with respect to the X-axis direction is formed. The second angle β is shown to be greater than the first angle α.

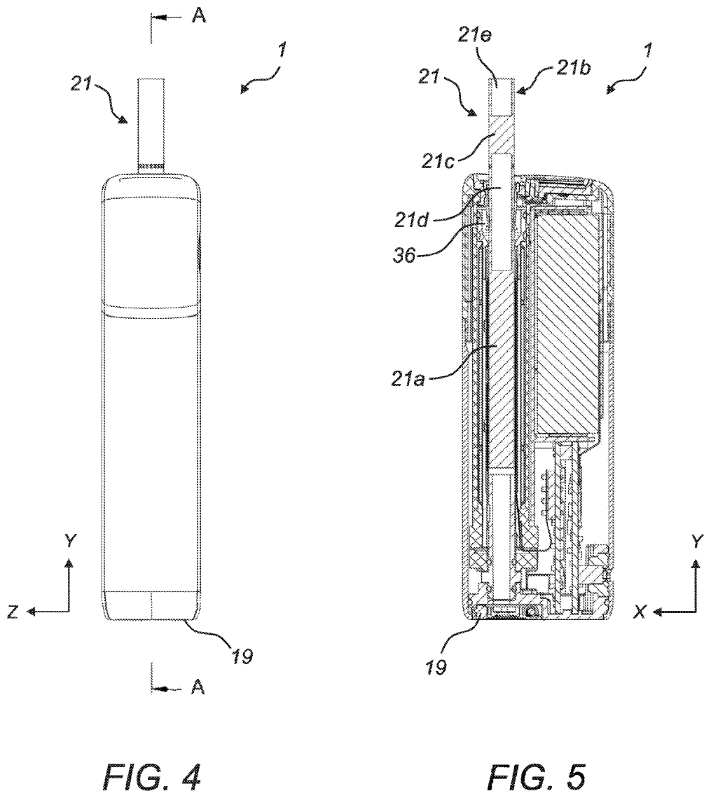

FIG. 3 and FIG. 4 respectively show a right-side and left-side of the apparatus 1. Here, the consumable article 21 is shown in a laterally central location. This is because the opening 20 through which the consumable article 21 is inserted is positioned at a mid-way point of the apparatus along the Z-axis direction and off-centre in the.

FIG. 5 and FIG. 6 show schematic front cross-sectional views of the apparatus 1 with the consumable article inserted and withdrawn, respectively through line A-A of the apparatus 1, as shown in FIG. 4.

As shown in FIG. 6, the casing 9 has located or fixed therein a heater arrangement 23, control circuitry 25 and the power source 27. In this embodiment, the control circuitry 25 is part of an electronics compartment and comprises two printed circuit boards (PCBs) 25a, 25b. The control circuitry 25 therefore comprises electrical components for controlling heating of the heating arrangement 23. In this embodiment, the control circuitry 25 and the power source 27 are laterally adjacent to the heater arrangement 23 (that is, adjacent when viewed from an end), with the control circuitry 25 being located below the power source 27. Advantageously, this provides allows the apparatus 1 to be compact in a lateral direction, corresponding to the X-axis direction.

The control circuitry 25 in this embodiment includes a controller, such as a microprocessor arrangement, configured and arranged to control the heating of the aerosolizable material in the consumable article 21, as discussed further below.

The power source 27 in this embodiment is a rechargeable battery. In other embodiments, a non-rechargeable battery, a capacitor, a battery-capacitor hybrid, or a connection to a mains electricity supply may be used. Examples of suitable batteries include for example a lithium-ion battery, a nickel battery (such as a nickel-cadmium battery), an alkaline battery and/or the like. The battery 27 is electrically coupled to the heater arrangement 23 to supply electrical power when required and under control of the control circuitry 25 to heat the aerosolizable material in the consumable (as discussed, to volatilise the aerosolizable material without causing the aerosolizable material to burn).

An advantage of locating the power source 27 laterally adjacent to the heater arrangement 23 is that a physically large power source 27 may be used without causing the apparatus 1, as a whole, to be unduly lengthy. As will be understood, in general, a physically large power source 27 has a higher capacity (that is, the total electrical energy that can be supplied, often measured in Amp-hours or the like) and thus the battery life for the apparatus 1 can be longer.

In one embodiment, the heater arrangement 23 is generally in the form of a hollow cylindrical tube, having a hollow interior heating chamber 29 into which the consumable article 21 comprising the aerosolizable material is inserted for heating, in use. Broadly speaking, the heating chamber 29 is a heating zone for receiving the consumable article 21. Different arrangements for the heater arrangement 23 are possible. In some embodiments, the heater arrangement 23 may comprise a single heating element or may be formed of plural heating elements aligned along the longitudinal axis of the heater arrangement 23. The or each heating element may be annular or tubular, or at least part-annular or part-tubular around its circumference. In an embodiment, the or each heating element may be a thin-film heater. In another embodiment, the or each heating element may be made of a ceramics material. Examples of suitable ceramics materials include alumina and aluminium nitride and silicon nitride ceramics, which may be laminated and sintered. Other heater arrangements are possible, including for example inductive heating, infrared heater elements, which heat by emitting infrared radiation, or resistive heating elements formed by for example a resistive electrical winding.

In this embodiment, the heater arrangement 23 is supported by a stainless steel support tube 75 and comprises a heater 71. In one embodiment, the heater 71 may comprise a substrate in which at least one electrically conductive element is formed. The substrate may be in the form of a sheet and may comprise for example a plastics layer. In a preferred embodiment the layer is a polyimide layer. The electrically conductive element/s may be printed or otherwise deposited in the substrate layer. The electrically conductive element/s may be encapsulated within or coated with the substrate.

The support tube 75 is a heating element that transfers heat to the consumable article 21. The support tube 75 comprises therefore heating material. In this embodiment, the heater material is stainless steel. In other embodiments, other metallic materials may be used as the heating material. For example, the heating material may comprise a metal or a metal alloy. The heating material may comprise one or more materials selected from the group consisting of: aluminium, gold, iron, nickel, cobalt, conductive carbon, graphite, steel, plain-carbon steel, mild steel, ferritic stainless steel, molybdenum, copper, and bronze.

The heater arrangement 23 is dimensioned so that substantially the whole of the aerosolizable material when the consumable article 21 is inserted in the apparatus 1 so that substantially the whole of the aerosolizable material is heated in use.

In some embodiments, the or each heating element may be arranged so that selected zones of the aerosolizable material can be independently heated, for example in turn (over time) or together (simultaneously) as desired.

The heater arrangement 23 in this embodiment is surrounded along at least part of its length by a vacuum region 31. The vacuum region 31 helps to reduce heat passing from the heater arrangement 23 to the exterior of the apparatus 1. This helps to keep down the power requirements for the heater arrangement 23 as it reduces heat losses generally. The vacuum region 31 also helps to keep the exterior of the apparatus 1 cool during operation of the heater arrangement 23. In some embodiments, the vacuum region 31 may be surrounded by a double-walled sleeve wherein the region between the two walls of the sleeve has been evacuated to provide a low-pressure region so as to minimise heat transfer by conduction or convection. In other embodiments, another insulating arrangement may be used, for example using heat insulating materials, including for example a suitable foam-type material, in addition to or instead of a vacuum region.

The casing 9, sometimes referred to as a housing, may further comprise various internal support structures 37 (best seen in FIG. 6) for supporting all internal components, as well as the heater arrangement 23.

The apparatus 1 further comprises a collar 33 which extends around and projects from the opening 20 into the interior of the housing 9 and an expansion element 35 which is located between the collar 33 and one end of the vacuum region 31. The expansion element 35 is a funnel that forms an expansion chamber 40 at the mouth end 3 of the apparatus 1. The collar 33 is a retainer for retaining the consumable article 21 (as is best shown in FIG. 5). In this embodiment, the retainer is reversibly removable from the apparatus 1.

One end of the expansion element 35 connects to and is supported by the first sleeve 11a and the other end of the expansion element 35 connects to and is support by one end of a cassette 51. A first sealing element 55, shown as an o-ring, is interposed between the expansion element 35 and the first sleeve 11a, and a second sealing element 57, also shown as an o-ring, is interposed between the expansion element 35 and the cassette 51. Each o-ring is made of silicone, however, other elastomeric materials may be used to provide the seal. The first and second sealing elements 55, 57 prevent the transmission of gas into surrounding components of the apparatus 1. Sealing elements are also provided at the distal end to prevent fluid ingress and egress at the distal end.

As best seen in FIG. 6, the collar 33, the expansion element 35 and the vacuum region 31/heater arrangement 23 are arranged co-axially, so that, as best seen in FIG. 5, when the consumable article 21 is inserted in the apparatus 1, the consumable article extends through the collar 33 and the expansion element 35 into the heating chamber 29.

As mentioned above, in this embodiment, the heater arrangement 23 is generally in the form of a hollow cylindrical tube. The heating chamber 29 formed by this tube is in fluid communication with the opening 20 at the mouth end 3 of the apparatus 1 via the expansion chamber 40.

In this embodiment, the expansion element 35 comprises a tubular body that has a first open end adjacent the opening 20 and a second open end adjacent the heating chamber 29. The tubular body comprises a first section that extends from the first open end to approximately half away along the tubular body and a second section that extends from approximately half away along the tubular body to the second open end. The first section comprises a flared portion that widens away from the second section. The first section therefore has an internal diameter that tapers outwardly towards the opening first open end. The second section has a substantially constant internal diameter.

As best seen in FIG. 6, in this embodiment, the expansion element 35 is located in the housing 9 between the collar 33 and the vacuum region 31/heater arrangement 23. More specifically, at the second open end, the expansion element 35 is interposed between an end portion of the support tube 75 of the heater arrangement 23 and an inside of the vacuum region 31 so that the second open end of the expansion element 35 engages with the support tube 75 and the inside of the vacuum region 31. At the first open end, the expansion element 35 receives the collar 33 so that legs 59 of the collar 33 project into the expansion chamber 40. Therefore, an inner diameter of the first section of the expansion element 35 is greater than an external diameter of the legs when the consumable article 21 is received in the apparatus 1 (see FIG. 5) and when no consumable article 21 is present.

As is best appreciated from FIG. 5, the inner diameter of the first section of the expansion element 35 is larger than the external diameter of the consumable article 21. There is therefore an air gap 36 between the expansion element 35 and the consumable article 21 when the consumable article 21 is inserted in the apparatus 1 over at least part of the length of the expansion element 35. The air gap 36 is around the entire circumference of the consumable article 21 in that region.

As best seen in FIG. 6, the collar 33 comprises a plurality of legs 59. In this embodiment there are four legs 59, where only three are visible in the view of FIG. 6. However, in other embodiments there may be more or fewer than four legs 59. The legs 59 are arranged circumferentially equally spaced around an inner surface of the collar 33 and exist in the expansion chamber 40 when the apparatus 1 is assembled. In this embodiment, when installed in the apparatus 1, the legs 59 are circumferentially equally spaced around the periphery of the opening 20. In one embodiment, there are four legs 59, in other embodiments there may be more or fewer than four legs 59. Each of the legs 59 extend in the Y-axis direction and parallel to the longitudinal axis of the expansion chamber 40 and project into the opening 20. The legs 59 also extend radially at a tip 59a of the leg 59 in a direction towards the expansion element 35 such that the tips 59a are angled away from each other. The tip 59a of each leg 59 provides for improved passage of the consumable article 21 so as to avoid damage to the consumable article 21 when inserting or removing the consumable article 21 from the apparatus 1. Together, the legs 59 provide a gripping section that grips the consumable article 21 in order to correctly position and retain the portion of the consumable article 21 that is within the expansion chamber 40 when the consumable article 21 is within the apparatus 1. Between them, the legs 59 gently compress or pinch the consumable article 21 in the region or regions of the consumable article that are contacted by the legs 59. The legs 59 may be comprised of a resilient material (or be resilient in some other way) so that they deform slightly (for example compress) to better grip the consumable article 21 when the consumable article 21 is inserted in the apparatus 1 but then regain their original shape when the consumable article 21 is removed from the apparatus 1 since the legs 59 are biased to a rest position shown in FIG. 6. Therefore, the legs 59 are reversibly movable from a first position, which is the rest position, to a second position, which is a deformed position shown in FIG. 5, whereby the consumable article 21 is gripped. In this embodiment, the legs 59 are formed integrally with a main body of the collar 33. However, in some embodiments, the legs 59 may be separate components that are attached to the body of the collar 33. The inner diameter of the space formed between the legs 59 in the first, rest position, may be, for example, between 4.8 mm and 5 mm, and preferably 4.9 mm. The legs 59 take up space within the opening 20 such that the open span of the opening 20 at the locations of the legs 59 is less than the open span of the opening 20 at the locations without the legs 59.

The expansion element 35 may be formed of for example a plastics material, including for example polyether ether ketone (PEEK). PEEK has a relatively high melting point compared to most other thermoplastics, and is highly resistant to thermal degradation.

Referring to FIG. 6, in this embodiment, the heating chamber 29 communicates with a region 38 of reduced internal diameter towards the distal end 5. This region 38 defines a clean-out chamber 39 formed by a clean-out tube 41. The clean-out tube 41 is a hollow tube that provides an end stop for the consumable article 21 passed through the opening at the mouth end 3 (see FIG. 5). The clean-out tube 41 is arranged to support and locate the heater arrangement 23.

The apparatus 1 may further comprise a door 61 at the distal end 5 of the apparatus 1 that opens and closes an opening in the bottom panel 19 to provide access to the heating chamber 29 so that the heating chamber 29 can be cleaned. The door 61 pivots about a hinge 63. This access through the door 61 particularly enables the user to clean within the heater arrangement 23 and the heating chamber 29 at the distal end 5. When the door 61 is open, a straight through-bore is provided through the whole apparatus 1 between the opening 20 at the mouth end 3 and an opening at one end of the clean-out chamber at the distal end 5 of the apparatus 1. The user is therefore easily able to clean through substantially the whole of the interior of the hollow heating chamber 29. For this, the user can access the heating chamber 29 via either end of the apparatus 1 at choice. The user may use one or more various cleaning devices for this purpose, including for example a classic pipe cleaner or a brush or the like.

As shown in FIG. 6, the top panel 17 generally forms the first end 3 of the housing 9 of the apparatus 1. The top panel 17 supports the collar 33 which defines an insertion point in the form of the opening 20 through which the consumable article 21 is removably inserted into the apparatus 1 in use.

The collar 33 extends around and projects from the opening 20 into the interior of the housing 9. In this embodiment, the collar 33 is a distinct element from the top panel 17, and is attached to the top panel 17 through an attachment, such as a bayonet locking mechanism. In other embodiments, an adhesive or screws may be used to couple the collar 33 to the top panel 17. In other embodiments, the collar 33 may be integral with the top panel 17 of the housing 9 so the collar 33 and the top panel 17 form a single piece.

As best appreciated from FIGS. 5 and 6, open spaces defined by adjacent pairs of legs 59 of the collar 33 and the consumable article 21 form ventilation paths 20a around the exterior of the consumable article 21. These ventilation paths 20a, allow hot vapors that have escaped from the consumable article 21 to exit the apparatus 1 and allow cooling air to flow into the apparatus 1 around the consumable article 21. In this embodiment, four ventilation paths are located around the periphery of the consumable article 21, which provide ventilation for the apparatus 1. In other embodiments, more or fewer of such ventilation paths 20a may be provided.

Referring again particularly to FIG. 5, in this embodiment, the consumable article 21 is in the form of a cylindrical rod which has or contains aerosolizable material 21a at a rear end in a section of the consumable article 21 that is within the heater arrangement 23 when the consumable article 21 is inserted in the apparatus 1. A front end of the consumable article 21 extends from the apparatus 1 and acts as the mouthpiece 21b which is an assembly that includes one or more of a filter for filtering aerosol or a cooling element 21c for cooling aerosol. The filter/cooling element 21c is spaced from the-aerosolizable material 21a by a space 21d and is also spaced from a tip of mouthpiece assembly 21b by a further space 21e. The consumable article 21 is circumferentially wrapped in an outer layer (not shown). In this embodiment, the outer layer of the consumable article 21 is permeable to allow some heated volatilised components from the aerosolizable material 21a to escape the consumable article 21.

In operation, the heater arrangement 23 will heat the consumable article 21 to volatilise at least one component of the aerosolizable material 21a.

The primary flow path for the heated volatilised components from the aerosolizable material 21a is axially through the consumable article 21, through the space 21d, the filter/cooling element 21c and the further space 21e before entering a user's mouth through the open end of the mouthpiece assembly 21b. However, some of the volatilised components may escape from the consumable article 21 through its permeable outer wrapper and into the space 36 surrounding the consumable article 21 in the expansion chamber 40.

It would be undesirable for the volatilised components that flow from the consumable article 21 into the expansion chamber 40 to be inhaled by the user, because these components would not pass through the filter/cooling element 21c and would thus be unfiltered and not cooled. Advantageously, the volume of air surrounding the consumable article 21 in the expansion chamber 40 causes at least some of the volatilised components that escape the consumable article 21 through its outer layer to cool and condense on the interior wall of the expansion chamber 40 preventing those volatilised components from being possibly inhaled by a user.

This cooling effect may be assisted by cool air that is able to enter from outside the apparatus 1 into the space 36 surrounding the consumable article 21 in the expansion chamber 40 via the ventilation paths 20a, which allows fluid to flow into and out of the apparatus. A first ventilation path is defined between a pair of the plurality of neighbouring legs 59 of the collar 33 to provide ventilation around the outside of the consumable article 21 at the insertion point. A second ventilation path is provided between a second pair of neighbouring legs 59 for at least one heated volatilised component to flow from the consumable article 21 at a second location. Therefore, ventilation is provided around the outside of the consumable article 21 at the insertion point by the first and second ventilation paths. Furthermore, heated volatilised components that escape the consumable article 21 through its outer wrapper do not condense on the internal wall of the expansion chamber 40 and are able to flow safely out of the apparatus 1 via the ventilation paths 20a without being inhaled by a user. The expansion chamber 40 and the ventilation both aid in reducing the temperature and the content of water vapor composition released in heated volatilised components from the aerosolizable material.

The apparatus 1 is fitted with a thermal liner 13 towards the first end 3 of the apparatus 1. As shown in FIG. 6, the liner 13 is coupled with the first sleeve 11a. The thermal liner 13 is a heat diffuser that helps to manage heat distribution and helps to protect the first sleeve 11a from thermal stress by distributing internal heat generated by use of the apparatus 1 over a larger area. The thermal liner 13 is made from a metallic material such as aluminium in order to be lightweight and sufficiently spread heat around the proximal end 3. This helps to avoid localised hot spots and increases the longevity of the first sleeve 11a. The liner 13 distributes heat by conduction. The liner 13 is not configured to insulate heat or reflect heat by radiation.

As shown in FIG. 6, the support tube 75 is externally wrapped by a heater 71. In this example, the heater 71 is a thin-film heater comprising polyimide and electrically conductive elements. The heater 71 may comprise a plurality of heating regions that are independently controlled or simultaneously controlled. In this example, the heater 71 is formed as a single heater. However, in other embodiments, the heater 71 may be formed of a plurality of heaters aligned along the longitudinal axis of the heating chamber 29. In some embodiments, a plurality of temperature sensors may be used to detect the temperature of the heater 71 or support tube. The support tube 75 in this embodiment is made from stainless steel to conduct heat from the heater 71 towards the consumable article 21 when the consumable article 21 is inserted in a heating zone (the heating zone is defined by the thermal conduction region of the support tube 75). In other embodiments, the support tube 75 may be made from a different material, as long as the support tube 75 is thermally conductive. Other heating elements 75 may be used in other embodiments. For example, the heating element may be a susceptor that is heatable by induction. In this embodiment, the support tube 75 acts as an elongate support for supporting, in use, the article 21 comprising aerosolizable material.

In this embodiment, the heater 71 is located externally of the support tube 75. However, in other embodiments, the heater 71 may be located internally of the support tube 75. The heater 71 in this embodiment comprises a portion that passes outside of the support tube 75 and is referred to herein as a heater tail 73. The heater tail 73 extends beyond the heating chamber 29 and is configured for electrical connection to the control circuitry 25. In the embodiment shown, the heater tail 73 physically connects to one PCB 25a. An electrical current may be provided by the power source 27 to the heater 71 via the control circuitry 25 and the heater tail 73.

As a connection between the heating chamber 29 and the control circuitry 25 is required, it can be difficult to prevent airflow (or the flow of any other fluids) between the heating chamber 29 and the electronics compartment. In this embodiment, a gasket 15 is used to prevent such fluid flow, as shown in FIG. 6. The gasket 15 comprises a first seal 15a and a second seal 15b. The gasket 15 surrounds the heater tail 73 and is clamped together by a base 53 and the cassette 51. In the embodiment shown, four fastening members 43 are used to provide the enough force to clamp the base 53 and cassette 51 together and seal off access to and from the chamber 29 at this point. The fastening members 43 are screws that are tightened to a predetermined torque. In other embodiments, different fastening members 43 may be used such as bolts.

As shown in FIG. 6, the heating arrangement 23 of the apparatus 1 is arranged in a first space of the apparatus 1. The heating zone 29 is positioned in the first space. In the embodiment shown, the heating zone 29 is elongate in order to receive an elongate article containing aerosolizable material through the opening 20. The elongate heating zone 29 is therefore for receiving and heating aerosolizable material.

A power zone is provided laterally adjacent to the heating zone 29 of the heating arrangement 23 in the X-axis direction. That is, the power zone is arranged in a direction substantially parallel with a longitudinal axis B-B of the elongate heating zone (shown by the dash-dot line). In this embodiment, the longitudinal axis B-B of the elongate heating zone 29 is parallel to the longitudinal axis of the apparatus 1. In the embodiment shown, the power zone is arranged to a right-side of the heating zone 29.

The power zone is a second space for installing the power source 27. That is, the power source 27 occupies the second space. The power source 27 is therefore installable in a compartment of the apparatus, wherein the compartment defines the second space.

In the embodiment shown in FIG. 6, the apparatus 1 comprises a chassis which is an internal support structure 37 of the apparatus 1. The power source 27 is combinable with and fitted to the chassis to independently support the power source 27. The chassis defines the power zone as a second space. The chassis defines the compartment previously referred to. The power source 27 is to provide heating power to heat the heating zone 29 so that the aerosolizable material can be heated when the aerosolizable material is in the heating zone 29.

The control circuitry 25 is located laterally adjacent to the heating zone 29 of the heating arrangement 23 in the X-axis direction. That is, the control circuitry 25 is arranged in a direction substantially parallel with the longitudinal axis B-B of the elongate heating zone. Furthermore, the control circuitry 25 is longitudinally adjacent (in the Y-axis direction) to the power source 27 and the power zone. That is, the power zone and the control circuitry are arranged sequentially in a longitudinal direction of the elongate heating zone 29. In the embodiment provided, the control circuitry 25 is located below the power zone and the control circuitry 25 is arranged more closely to a distal end 5 of the apparatus 1 than the power zone. As previously discussed, the control circuitry 25 is for controlling the heating power.

The control circuitry 25 and heating arrangement 23 are both fitted to another chassis, which is shown as the bottom panel 19. The bottom panel defines a space for receiving the control circuitry 25. The bottom panel 19 independently supports the heating arrangement 23 and control circuitry 25.

As shown in FIG. 6, the elongate heating zone 29 of the heating arrangement 23 is arranged laterally to both the power zone and the control circuitry 25. In the longitudinal direction (the Y-axis direction), the elongate heating zone 29 overlaps with a portion of the power zone and a portion of the control circuitry 25. The elongate heating zone 29 is shown in FIG. 6 with the longitudinal axis B-B extending in the Y-axis direction. The power zone and the control circuitry 25 are therefore arranged sequentially in a direction substantially parallel with the longitudinal axis B-B of the elongate heating zone 29. That is, the power zone and the control circuitry 25 are arranged consecutively (in sequence) in the Y-axis direction, wherein the power zone is above the control circuitry 25 and closer to the proximal end 3 of the apparatus 1 than the control circuitry 25.

The power zone is positioned closer to the opening 20 of the apparatus 1 than the control circuitry is positioned to the opening 20. When the consumable article 21 is inserted into the heating zone 29, a proximal end of the consumable article 21 is passed longitudinally along the power zone before being passed longitudinally along the control circuitry 25. When fully inserted, as shown in FIG. 5, the consumable article 21 is beside both the power zone and the control circuitry 25. In the embodiment shown, when the consumable article 21 is fully inserted, a majority length of the consumable article 21 is adjacent the power zone and a minority length is adjacent the control circuitry 25. That is, an end of the heating zone 29 is positioned lateral to the control circuitry 25 and not the power zone because the power zone is positioned longitudinally above the end of the heating zone 29.

As shown in FIGS. 5 and 6, the two PCBs 25a, 25b of the apparatus 1, are arranged sequentially in a lateral direction (the X-axis direction). The two PCBs 25a, 25b are shown as a split PCB in that the two 25a, 25b are electrically coupled. A first PCB 25a is positioned further from the heating zone 29 than a second PCB 25b is positioned to the heating zone 29. In the embodiment shown, the first PCB 25a is to electrically connect with the power source 27 and the second PCB 25b is to electrically connect with the heater 71 and specifically the heater tail 73. In other embodiments, the electrical connections to the PCBs 25a, 25b may be the other way around. The first PCB 25a is electrically connected to the connection port 6, such as a USB port, for electrically connecting the apparatus 1 to an external electrical source (not shown). The connection port 6 is arranged at an end opposite the opening 20 for receiving aerosolizable material. The electrical connection port 6 faces outwardly of the apparatus 1 in the lateral direction (the X-axis direction).

As shown in FIGS. 5 and 6, each of the PCBs 25a, 25b has the same length in the Y-axis direction. This allows the control circuitry 25 to be compact to reduce the overall length of the apparatus 1. The power zone is longer than the control circuitry 25 but shorter than the heating arrangement 23.

The length of each PCB 25a, 25b (in the Y-direction) is 36.6 mm. In some embodiments, the length of each PCB 25a, 25b may be between 36 mm and 37 mm. The depth of each PCB 25a, 25b (in the X-direction) is 1.2 mm. The depth may therefore be referred to as a thickness. In some embodiments, the depth of each PCB 25a, 25b is between 1 mm and 1.5 mm. A gap is shown between each PCB 25a, 25b. In this embodiment, the gap is around twice the depth of the PCBs 25a, 25b.

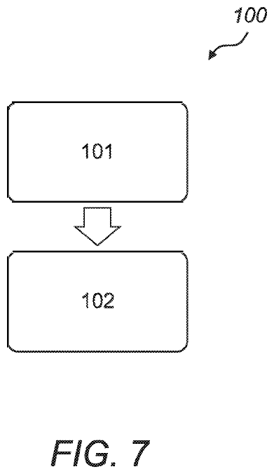

Referring to FIG. 7, a flow diagram is shown. The flow diagram shows an example of a method 100 of arranging an apparatus for heating aerosolizable material to volatilise at least one component of the aerosolizable material. The method is suitable for the apparatus 1 shown in the FIGS. 1 to 6.

The method 100 comprises the step of providing a heating arrangement 101 comprising an elongate heating zone for receiving and heating aerosolizable material and arranging in sequence 102 a power zone and control circuitry in a direction substantially parallel with a longitudinal axis of the apparatus, wherein the power zone is for installing a power source for providing heating power to heat the heating zone, and wherein the elongate heating zone is arranged adjacent to and substantially in parallel with the power zone and the control circuitry. That is, the power zone and control circuitry are stacked on top of each other. When arranged, the elongate heating zone is lateral to the power zone and the control circuitry.

In some embodiments, the arranging 102 comprises arranging in sequence a power source of the power zone and the control circuitry in the direction substantially parallel with the longitudinal axis of the apparatus. In some embodiments, the method 100 comprises installing a power source in the power zone.

In some embodiments, the aerosolizable material comprises tobacco. However, in other embodiments, the aerosolizable material may consist of tobacco, may consist substantially entirely of tobacco, may comprise tobacco and aerosolizable material other than tobacco, may comprise aerosolizable material other than tobacco, or may be free from tobacco. In some embodiments, the aerosolizable material may comprise a vapor or aerosol forming agent or a humectant, such as glycerol, propylene glycol, triacetin, or diethylene glycol.

In some embodiments, the aerosolizable material is non-liquid aerosolizable material, and the apparatus is for heating non-liquid-aerosolizable material to volatilise at least one component of the aerosolizable material.

Once all, or substantially all, of the volatilisable component(s) of the aerosolizable material in the consumable article 21 has/have been spent, the user may remove the article 21 from the apparatus 1 and dispose of the article 21. The user may subsequently re-use the apparatus 1 with another of the articles 21. However, in other respective embodiments, the article may be non-consumable, and the apparatus and the article may be disposed of together once the volatilisable component(s) of the aerosolizable material has/have been spent.

In embodiments described herein the consumable article 21 comprises a mouthpiece assembly 21b. However, it will be appreciated that in other embodiments an example apparatus as described herein may comprise a mouthpiece. For example, the apparatus 1 may comprise a mouthpiece which is integral with the apparatus, or in other embodiments the apparatus may comprise a mouthpiece which is detachably attached to the apparatus 1. In an example, the apparatus 1 may be configured to receive material to be heated. The aerosolizable material may be contained in a consumable article not comprising a mouthpiece portion. A user may draw on the mouthpiece of the apparatus 1 to inhale aerosol generated by the apparatus by heating the aerosolizable material.

In some embodiments, the article 21 is sold, supplied or otherwise provided separately from the apparatus 1 with which the article 21 is usable. However, in some embodiments, the apparatus 1 and one or more of the articles 21 may be provided together as a system, such as a kit or an assembly, possibly with additional components, such as cleaning utensils.

In order to address various issues and advance the art, the entirety of this disclosure shows by way of illustration and example various embodiments in which the disclosure may be practised and which provide for superior heating elements for use with apparatus for heating aerosolizable material, methods of forming a heating element for use with apparatus for heating aerosolizable material to volatilise at least one component of the aerosolizable material, and systems comprising apparatus for heating material to volatilise at least one component of the aerosolizable material and a heating element heatable by such apparatus. The advantages and features of the disclosure are of a representative sample of embodiments only, and are not exhaustive or exclusive. They are presented only to assist in understanding and teach the claimed and otherwise disclosed features. It is to be understood that advantages, embodiments, examples, functions, features, structures or other aspects of the disclosure are not to be considered limitations on the disclosure as defined by the claims or limitations on equivalents to the claims, and that other embodiments may be utilised and modifications may be made without departing from the scope or spirit of the disclosure. Various embodiments may suitably comprise, consist of, or consist in essence of, various combinations of the disclosed elements, components, features, parts, steps, means, etc. The disclosure may include other embodiments not presently claimed, but which may be claimed in future.

1. An aerosol provision system comprising:
a reservoir for containing an aerosol precursor material;
an inlet port and an outlet port both fluidly connected to the reservoir; and
a control unit configured to supply a pressurized fluid to the reservoir via the inlet port to increase the pressure within the reservoir relative to the pressure external to the reservoir to force the aerosol precursor material to exit the reservoir via the outlet port.

2. The aerosol provision system of claim 1, wherein the outlet port is configured to allow aerosol precursor material to exit the reservoir via the outlet port when the pressure within the reservoir is greater than or equal to a threshold pressure.

3. The aerosol provision system of claim 1, further comprising a source of pressurized fluid, wherein the source of pressurized fluid is configured to be able to fluidly communicate with the inlet port of the reservoir.

4. The electronic aerosol provision system of claim 3, wherein the source of pressurized fluid is at least one of: a pressurized fluid generator for generating pressurized fluid and a store of pre-pressurized fluid.

5. The electronic aerosol provision system of claim 1, wherein the control unit further comprises a controller, the controller configured to control the flow of pressurized fluid.

6. The electronic aerosol provision system of claim 5, wherein the controller is configured to control the amount of aerosol precursor material exiting the reservoir by controlling the amount of pressurized fluid entering the reservoir.

7. The electronic aerosol provision system of claim 6, wherein the controller is configured to receive an input, and control the flow of pressurized fluid based on the input.

8. The electronic aerosol provision system of claim 1, wherein the outlet port comprises a valve.

9. The electronic aerosol provision system of claim 1, wherein the inlet port comprises a valve.

10. The electronic aerosol provision system of claim 9, wherein the valve of the inlet port is configured to open in response to the pressurized fluid.

11. The electronic aerosol provision system of claim 9, wherein the valve of the inlet port is configured to open when the pressure applied by the pressurized fluid exceeds a first threshold, and wherein the outlet valve is configured to open when the pressure within the reservoir exceeds a second threshold.

12. The electronic aerosol provision system of claim 1, wherein the control unit comprises a pump configured to selectively generate the pressurized fluid, wherein the pump is arranged in fluid communication with the inlet port.

13. The electronic aerosol provision system of claim 1, wherein the control unit comprises a pre-pressurized container containing the pressurized fluid and configured to selectively release the pressurized fluid, wherein the pre-pressurized container is arranged in fluid communication with the inlet port.

14. The electronic aerosol provision system of claim 1, wherein the control unit comprises a housing, the housing defining a pressurized fluid pathway configured to fluidly couple to the inlet port and permit pressurized fluid to flow along the pressurized fluid path to the inlet port.

15. The electronic aerosol provision system of claim 14, wherein the housing further defines an aerosol precursor pathway configured to allow aerosol precursor material to pass along the aerosol precursor pathway.

16. The electronic aerosol provision system of claim 1, wherein the control unit comprises an atomizer, and wherein the outlet port is arranged such that aerosol precursor material exiting via the outlet port is atomized by the atomizer.

17. The electronic aerosol provision system of claim 1, wherein the pressurized fluid is a gas.

18. The electronic aerosol provision system of claim 1, wherein the system comprises a cartridge separable from the control unit, the cartridge comprising the reservoir, inlet port and outlet port.

19. The electronic aerosol provision system of claim 18, wherein the inlet port and outlet port both comprise a valve, and wherein the inlet valve and the outlet valve are configured to be closed when the cartridge is removed from the housing.

20. An aerosol provision device comprising a control unit configured to allow a pressurized fluid to enter a reservoir for containing an aerosol precursor material via an inlet port fluidly connected to the reservoir to increase the pressure within the reservoir relative to the pressure external to the reservoir to force the aerosol precursor material to exit the reservoir via an outlet port fluidly connected to the reservoir.

21. A cartridge including a reservoir for containing an aerosol precursor material, and an inlet port for receiving a pressurized fluid and an outlet port both fluidly connected to the reservoir, wherein the cartridge is configured to permit the release of aerosol precursor material from the outlet port when the pressure in the reservoir exceeds a threshold value.

22. A method of dispensing aerosol precursor material from a reservoir, the reservoir comprising an inlet port and an outlet port fluidly coupled to the reservoir, the method comprising:
permitting a pressurized fluid to enter the reservoir via the inlet port to increase the pressure within the reservoir relative to the pressure external to the reservoir, and
dispensing aerosol precursor material from the reservoir in response to the increased pressure forcing the aerosol precursor material to exit the reservoir via the outlet port.

23. A method of dispensing aerosol precursor material from a reservoir, the method comprising:
increasing the pressure within the reservoir to a value greater than or equal to a threshold value, above which aerosol precursor material is permitted to exit the reservoir and below which aerosol precursor material is not permitted to exit the reservoir.

24. The method of claim 22, wherein the pressure within the reservoir is a first value prior to increasing the pressure in the reservoir, and wherein the pressure within the reservoir increases to a second value, before dropping to a third value when the aerosol precursor material exits the reservoir.
